(19) United States
(12) Patent Application Publication
(10) Pub. No.: US 2017/0302039 A1
(43) Pub. Date: Oct. 19, 2017

(54) LOAD CENTER AND BUSWAY

(71) Applicant: QTran, Inc., Milford, CT (US)

(72) Inventors: John M. Tremaine, New Canaan, CT (US); Adrian Teschemaker, West Haven, CT (US)

(21) Appl. No.: 15/448,947

(22) Filed: Mar. 3, 2017

Related U.S. Application Data
(60) Provisional application No. 62/304,266, filed on Mar. 6, 2016.

(51) Int. Cl. H01R 25/00; H02B 1/20; H01B 1/02

(52) U.S. Cl. CPC H01R 25/00; H01B 1/02; H02B 1/20

(57) ABSTRACT

The present invention generally relates to a load center and a busway, and more particularly relates to a load center that is configured to be efficiently electrically connected to an electrical distribution busway. The busway may include a bus system having one or more bus conductors, and a T-buss extending from the bus system and having one or more flat-bar conductors. Each of the one or more bus conductors may be electrically coupled to a corresponding one of the one or more flat-bar conductors.

### BACKGROUND OF THE INVENTION

### 1. Field of the Invention

The present invention generally relates to a load center and a busway, and more particularly relates to a load center that is configured to be efficiently electrically connected to an electrical distribution busway.

### SUMMARY OF THE INVENTION

The present invention is designed to overcome the above noted limitations that are attendant upon the use of conventional load centers and busways and, toward this end, it contemplates the provision of a novel load center and busway.

It is an object of the present invention to provide a busway that obviates the time consuming and expensive operation of installing electrical wires/cables in a building structure.

It is an object of the present invention to provide a load center that is pre-wired in order to allow for efficient and inexpensive installation of the load center interconnection of the load center to the electrical systems of a building structure.

It is yet another object of the present invention to reduce the number of electrical meters required for a multi-unit building structure.

It is still another object of the present invention to provide a busway configured to interconnection to a load center and connection to other busways located throughout the building structure by one or more electrically conducting posts.

It is yet another object of the present invention to reduce and/or eliminate the number of electrical connections required during the construction of a building structure to be made by a licensed and/or certified electrician.

It is still another object of the present invention to reduce and/or eliminate the number of electric components of a building structure that require inspection and/or certification by a governing body after installation of the electric components.

It has now been found that the foregoing and related objects can be readily attained in a load center and busway as shown and described in the present application.

In accordance with an exemplary embodiment of the present invention, a busway is provided that includes a bus system having one or more bus conductors, and a T-buss extending from the bus system and having one or more flat-bar conductors. Each of the one or more bus conductors is electrically coupled to a corresponding one of the one or more flat-bar conductors.

In accordance with this or other exemplary embodiments of the present invention, each of the one or more bus conductors may be constructed of of an electrically conductive flat-bar.

In accordance with this or other exemplary embodiments of the present invention, each of the one or more bus conductors may be constructed of an electrically conductive cable.

In accordance with this or other exemplary embodiments of the present invention, the T-buss may extend substantially perpendicular to the bus system.

In accordance with this or other exemplary embodiments of the present invention, the bus system may be configured for connection to another bus system of another busway through one or more electrical buss conductors.

In accordance with this or other exemplary embodiments of the present invention, each of the one or more flat-bar conductors may include a lug for electrical connection to an electrical wire.

In accordance with this or other exemplary embodiments of the present invention, each of the one or more flat-bar conductors may be configured for electrical connection to an electrical wire of a load center.

In accordance with this or other exemplary embodiments of the present invention, the load center may include an enclosure having one or more circuit breakers disposed therein and a skirt extending from the enclosure.

In accordance with this or other exemplary embodiments of the present invention, the one or more flat-bar conductors may be electrically coupled the corresponding electrical wire of a load center by a lug.

In accordance with this or other exemplary embodiments of the present invention, the electrical wire connections of the load center may be made prior to electrically coupling the load center to the one or more flat-bar conductors.

In accordance with this or other exemplary embodiments of the present invention, wherein the one or more bus conductors may be made of copper or aluminum.

In accordance with this or other exemplary embodiments of the present invention, the one or more bus conductors and the one or more flat-bar conductors may be constructed of a rigid conductive material.

### BRIEF DESCRIPTION OF THE SEVERAL VIEWS OF THE DRAWINGS

For a fuller understanding of the nature and object of the present invention, reference should be had to the following detailed description taken in connection with the accompanying drawings, in which:

FIG. 1 is a front view of an exemplary wall of a building structure that may be used with various exemplary embodiments of the present invention;

FIG. 2 is an isometric view of the exemplary wall of a building structure that may be used with various exemplary embodiments of the present invention;

FIG. 3 is a top view of an exemplary busway according to the present invention;

FIG. 4 is a front view of the exemplary busway according to the present invention;

FIG. 5 is a side view of the exemplary busway according to the present invention;

FIG. 6 is an isometric view of the exemplary busway according to the present invention;

FIG. 7 is a front view of the installation of the exemplary busway according to the present invention on the exemplary wall;

FIG. 8 is a side view of the exemplary busway installed on the exemplary wall;

FIG. 9 is an isometric view of the exemplary busway installed on the exemplary wall;

FIG. 10 is a front view of a bottom portion of an exemplary embodiment of a protective housing for the exemplary busway installed on the exemplary wall according to the present invention;

FIG. 11 is an isometric view of the bottom portion of the exemplary embodiment of the protective housing for the exemplary busway installed on the exemplary wall according to the present invention;

FIG. 12 is a front view of the bottom portion and a top portion of the exemplary embodiment of the protective housing for the exemplary busway installed on the exemplary wall according to the present invention;

FIG. 13 is an isometric view of the bottom portion and the top portion of the exemplary embodiment of the protective housing for the exemplary busway installed on the exemplary wall according to the present invention;

FIG. 14 is a front view of the bottom portion and the top portion of the exemplary embodiment of the protective housing for the exemplary busway installed on the exemplary wall according to the present invention;

FIG. 15 is a front view of the exemplary embodiment of the protective housing for the exemplary busway installed on the exemplary wall according to the present invention;

FIG. 16 is a rear view of the exemplary busway installed on the exemplary wall and connected to electrical conductors;

FIG. 17 is an isometric rear view of the exemplary busway installed on the exemplary wall showing t-connector (main connector above and below not shown);

FIG. 18 is a top view of the exemplary embodiment of the protective housing for the exemplary busway installed on the exemplary wall according to the present invention;

FIG. 19 is an isometric view of the exemplary embodiment of the protective housing for the exemplary busway installed on the exemplary wall according to the present invention;

FIG. 20 is an isometric view showing the installation of an exemplary load center according to the present invention on the exemplary wall and relative to the exemplary embodiment of the protective housing;

FIG. 21 is an isometric view of the exemplary load center according to the present invention installed on the exemplary wall;

FIG. 22 is an isometric view of the exemplary load center according to the present invention with its access door in an open position;

FIG. 23 is a front view of the exemplary load center and bus enclosures with their covers removed in order to show an exemplary electrical interconnection of the load center with the exemplary busway according to the present invention;

FIG. 24 is an isometric view of the exemplary load center according to the present invention;

FIG. 25 is a front view of the exemplary load center with its cover removed in order to show the internal electrical components of the load center;

FIG. 26 is a front view of the exemplary load center with its access door removed;

FIG. 27 is a front view of the exemplary load center with the access door closed; and

FIG. 28 is an isometric view of the exemplary embodiment of the protective housing for the busway according to the present invention.

### DETAILED DESCRIPTION OF THE INVENTION

The present invention now will be described more fully hereinafter with reference to the accompanying figures, in which exemplary embodiments of the invention are shown. The invention may, however, be embodied in many different forms and should not be construed as limited to the embodiments set forth herein. Like reference numerals refer to like elements throughout.

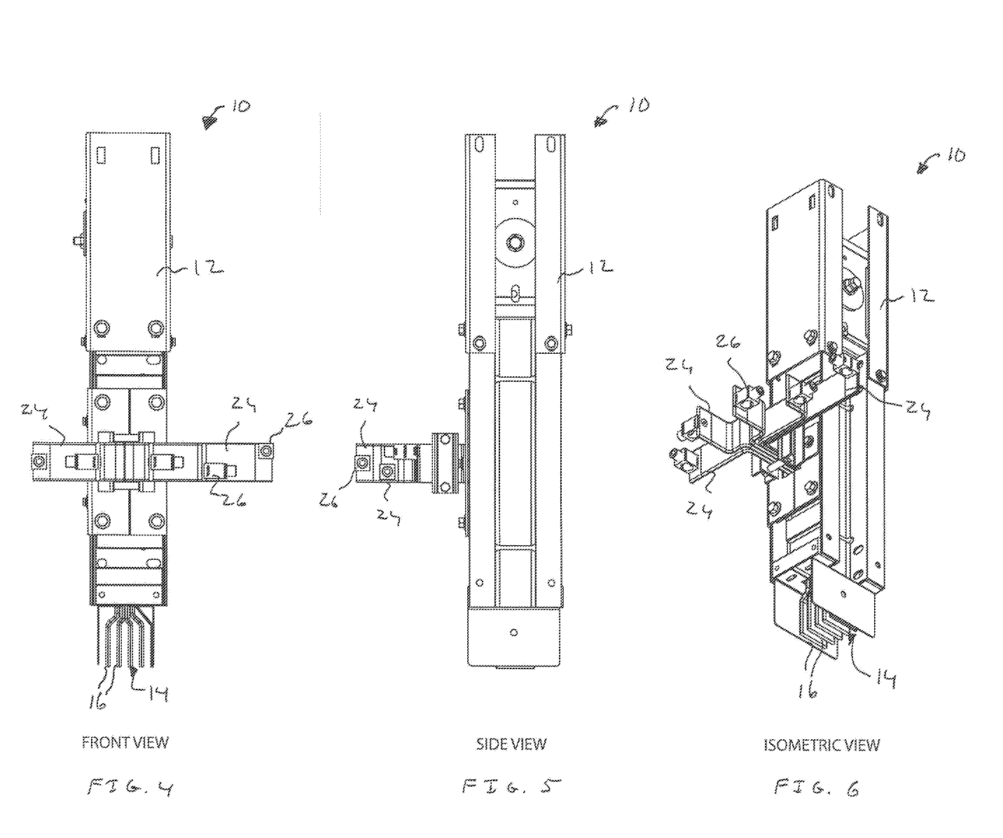

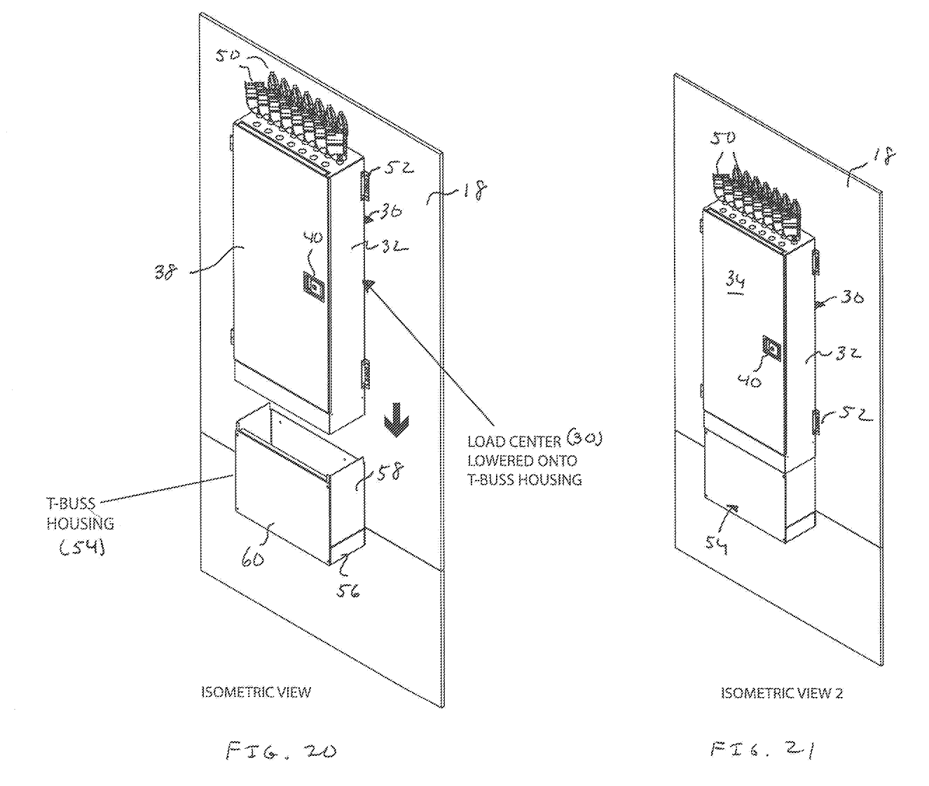

Referring now to FIGS. 3-6 and 16-18, therein illustrated is an exemplary busway, generally indicated by reference numeral 10, according to the present invention. It is understood that the busway 10 may be a flat-bar busway or a cable busway, and that the exemplary embodiment illustrated in the figures represents a flat-bar busway, but that the present invention is not limited to any particular construction of the busway 10. The busway 10 includes at least one protective cover 12, a support system (not shown), a bus system 14 comprised of one or more conductors 16, and a T-buss 17 extending from the busway 10, which T-buss provides an electrical distribution point from the busway 10.

As shown specifically in FIG. 16, the bus system 14 of the busway 10 is configured to connect the busway 10 to electrical buss conductors 22, such as a copper bar buss, in order to electrically connect the busway 10 to a main electrical line and/or source and to other busways located throughout the building structure. It is understood that the individual conductors 16 of the bus system 14 are electrically connected to the appropriate conductors of the electrical buss conductors 22 in order to complete and/or extend the electrical system of the building structure.

Referring again to FIGS. 3-6 and 16-18, the T-buss 17 of the busway 10 may also include one or more flat-bar conductors 24 that are each electrically connected to the appropriate conductor 16 from the cable bus system 14. For example, the ground (GND) flat-bar conductor 24 is electrically connected to the ground (GND) conductor 16, the neutral (NEU) flat-bar conductor 24 is electrically connected to the neutral (NEU) conductor 16, and so on. Each flat-bar conductor 24 may also include an electrical connection device 26, such as a lug, that is configured to allow further electrical connection of electrical wires and/or conductors to the busway 10. While one or more flat-bar conductors 24 have been illustrated with the present exemplary embodiment of the invention, it is understood that cable conductors are also suitable for the present invention, and that the present invention is not limited to flat-bar conductors 24. Furthermore, the conductor 16 of the cable bus system 14 may be made from any suitably conductive metal, such as copper or aluminum, and the one or more flat-bar conductors 24 may likewise be made from any suitably conductive metal, such as copper or aluminum. It is understood that the present invention is not limited to any particular material used to make the conductor 16 and/or flat-bar conductors 24.

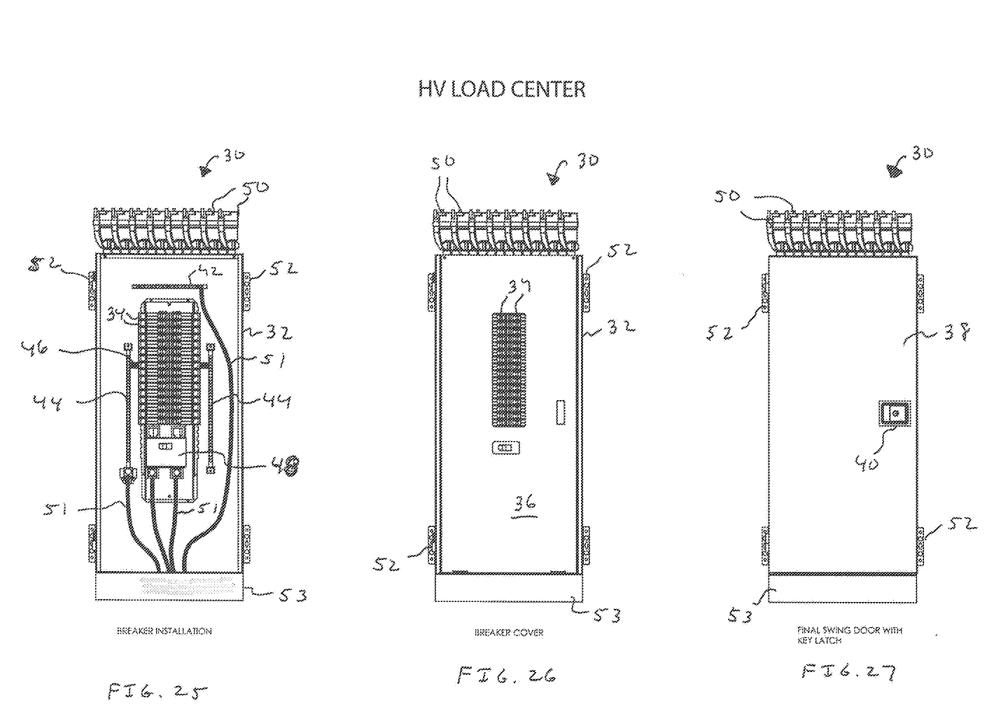

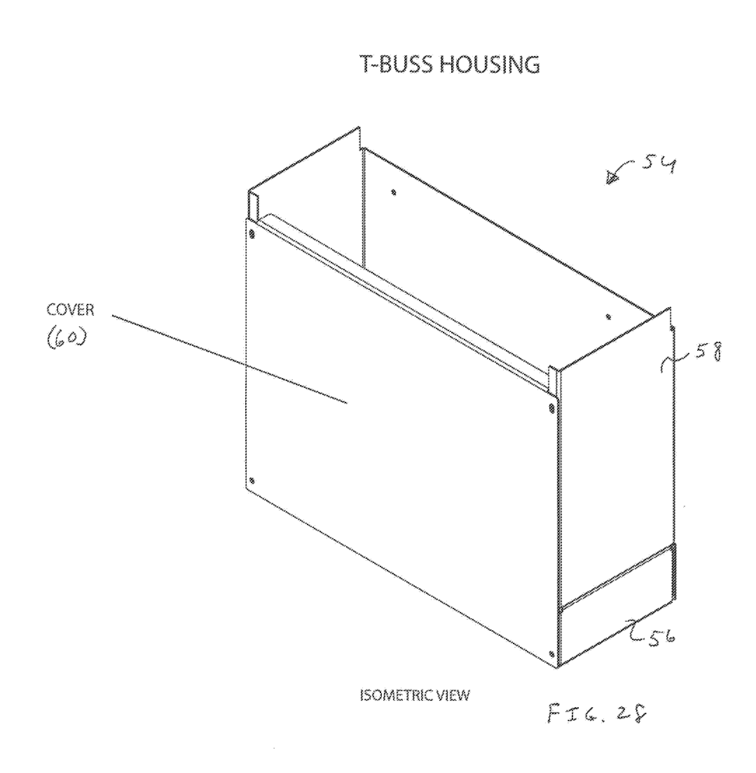

Referring now to FIGS. 20-27, therein illustrated is an exemplary embodiment of a load center, generally indicated by reference numeral 30, according to the present invention. It is understood that the load center 30 may be configured to efficiently connect to the flat-bar conductors 24 of the T-buss 17, but that the combination of the load center 30 and the T-buss 17 is not required for the present invention. The load center 30 may include an enclosure 32 that defines an interior region for housing one or more circuit breakers 34 within the load center 30. The one or more circuit breakers 34 may be covered by a circuit breaker cover 36 that encloses the interior region defined by the enclosure 32. The circuit breaker cover 36 may be removable or fixed in place, or only removable through use of tools in order to provide limited access to the interior of the enclosure 32. The load center 30 may also include a swing door 38 attached to the enclosure 32 by one or more hinges, and may preferably be removable from the enclosure 32. The swing door 38 acts to cover the circuit breakers 34 and the circuit breaker cover 36. The swing door 38 may include a keyed pull latch 40, it is understood that the pull latch 40 may also be unkeyed, that secures the swing door 38 to the circuit breaker cover 36 when the swing door 38 is closed, and also may control access to the load center 30 by providing a locking mechanism for the load center 30.

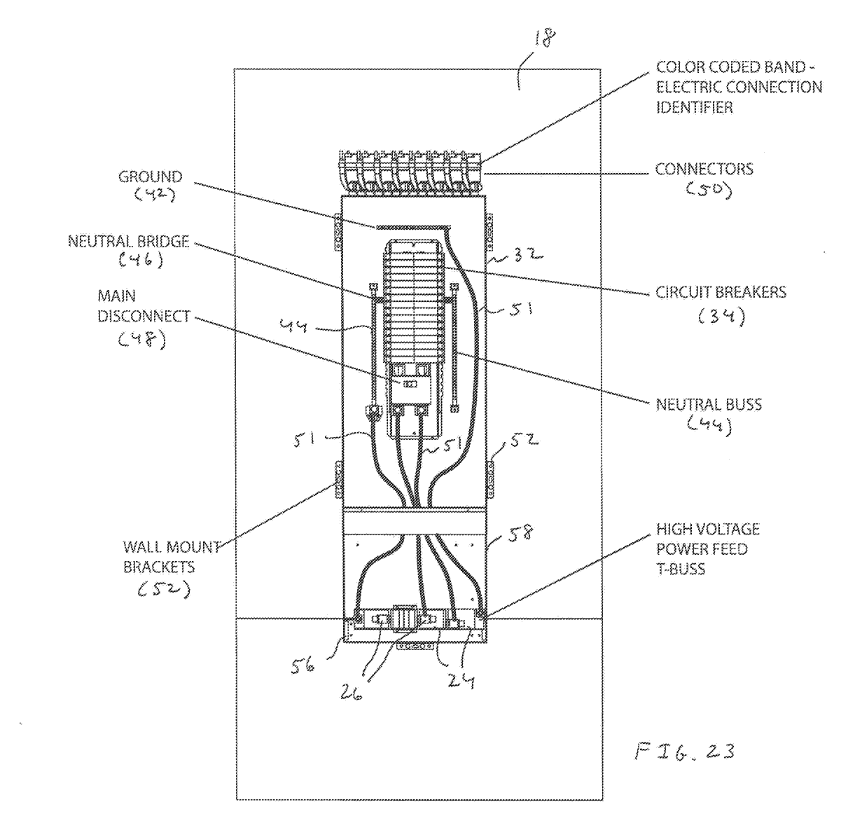

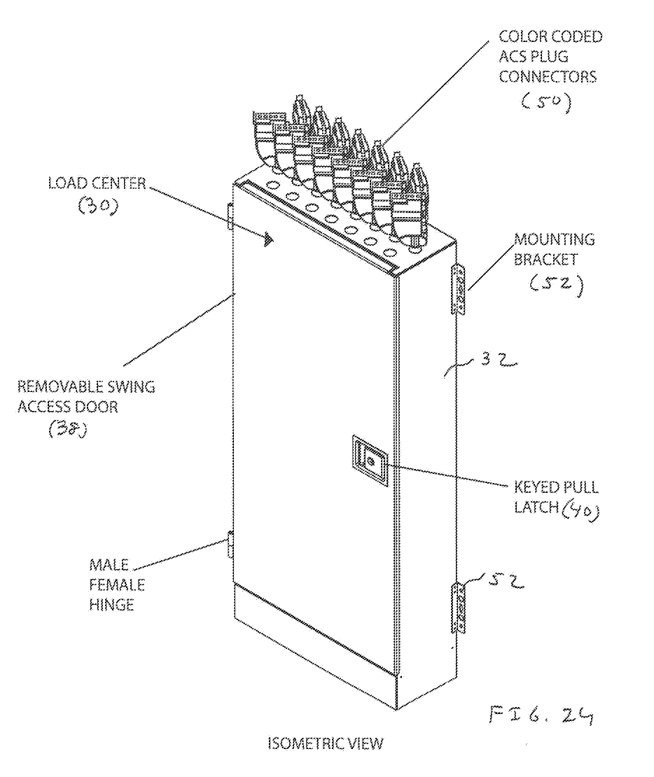

Referring now particularly to FIGS. 23 and 25, the load center 30 may include suitable electronic components in the interior region of the enclosure 32 in order to permit the load center 30 to act as an electrical distribution panel to one or more units, such as a residential, commercial or industrial unit. An example of a residential unit may be an apartment or a condominium, but it is understood that the present invention is not limited to any particular type of unit. The electrical components of the load center 30 may include a ground bar 42, one or more neutral buses 44 with a neutral bridge 46 connecting the neutral buses and a main disconnect 48, which may be in the form of a breaker and/or switch, that is configured to be operable to electrically separate the electricity entering the load center 30 from the bar buss 22 from the circuit breakers 34 connected to the one or more units. The load center 30 may also be configured for connection to one or more connectors 50 that may be electrically connected to individual breakers 34, so that each connector 50 is electrically connected to a single breaker 34. The connectors 50 may then be electrically connected to electrical systems and/or components that service the units. Preferably, the breakers 34 are electrically connected to the appropriate connector 50 prior to installation of the load center 30 in the building structure or facility containing the units. In this manner, it is unnecessary to make all of the electrical connections between the connectors 50 and the breakers 34 at the time that the load center 30 is installed, thereby saving significant amounts of man-hours at the site of the building structure or facility. Even more preferably, the connectors 50 may be of such a design so that a certified electrician is not required by code or ordinance to make the connections. The load center 30 may also include wires 51 that are connected to the electrical components of the load center 30. The wires 51 may preferably be factory installed and connected to the appropriate lugs of the corresponding electrical component. For example, a suitable wire 51 may be connected to one of the lugs of the ground bar 42, a second suitable wire may be connected to a lug of the neutral buss 44, and an appropriate number of suitable wires 51 may be connected to the feed lugs of the main disconnect 48. The load center 30 may also include a skirt 53 that extends from the bottom of the load center 30, and is configured to provide protection for the pre-connected wires during transport and/or installation of the load center 30.

Referring again to FIGS. 20-27, the load center 30 may also include one or more wall mounting brackets 52 that can be used to securely fasten the load center 30 to a wall 18 of the building structure or facility.

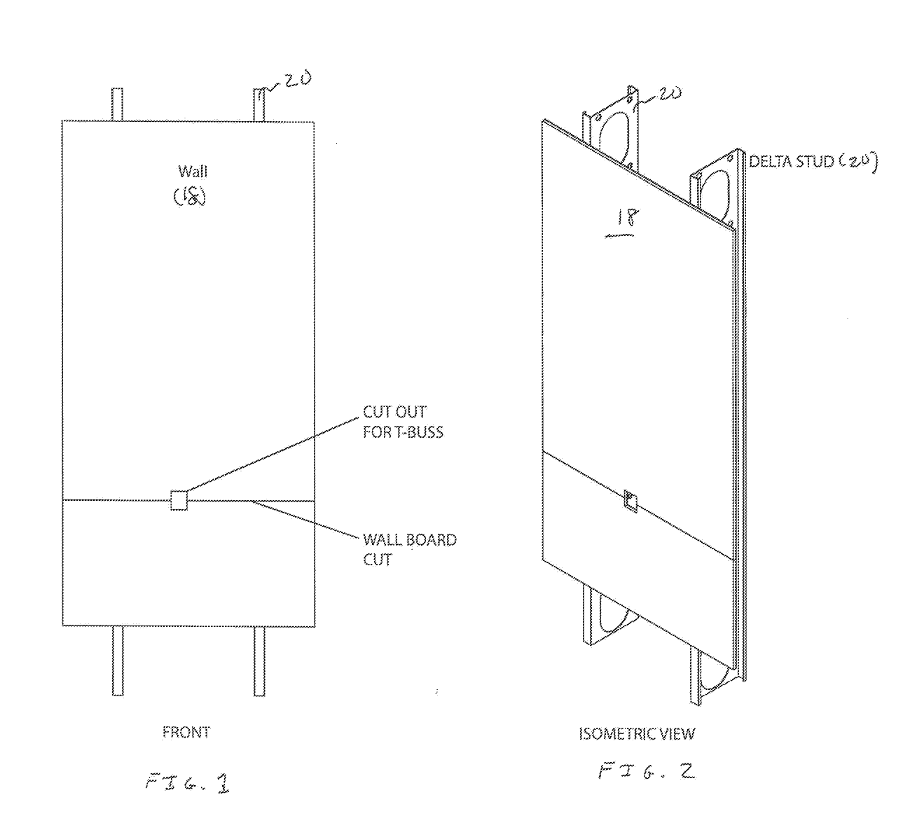

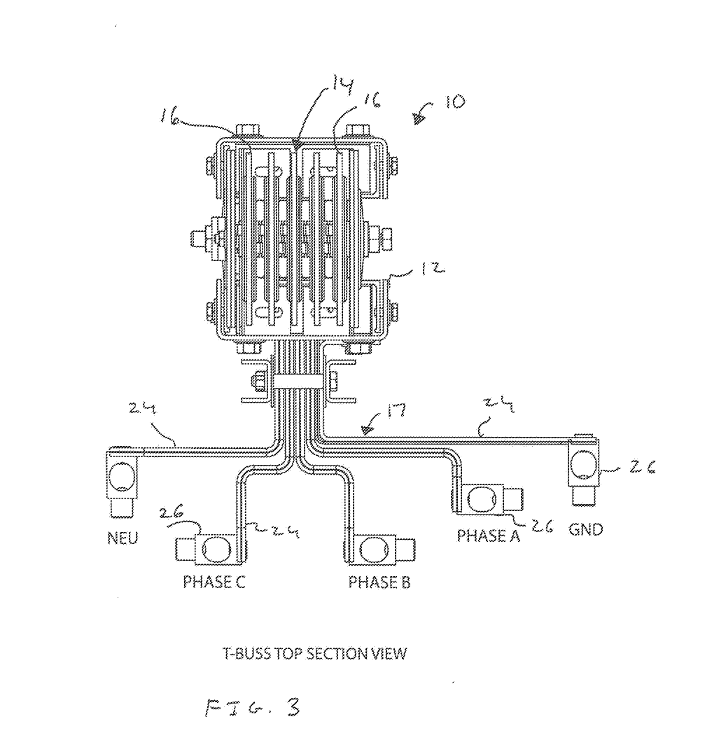

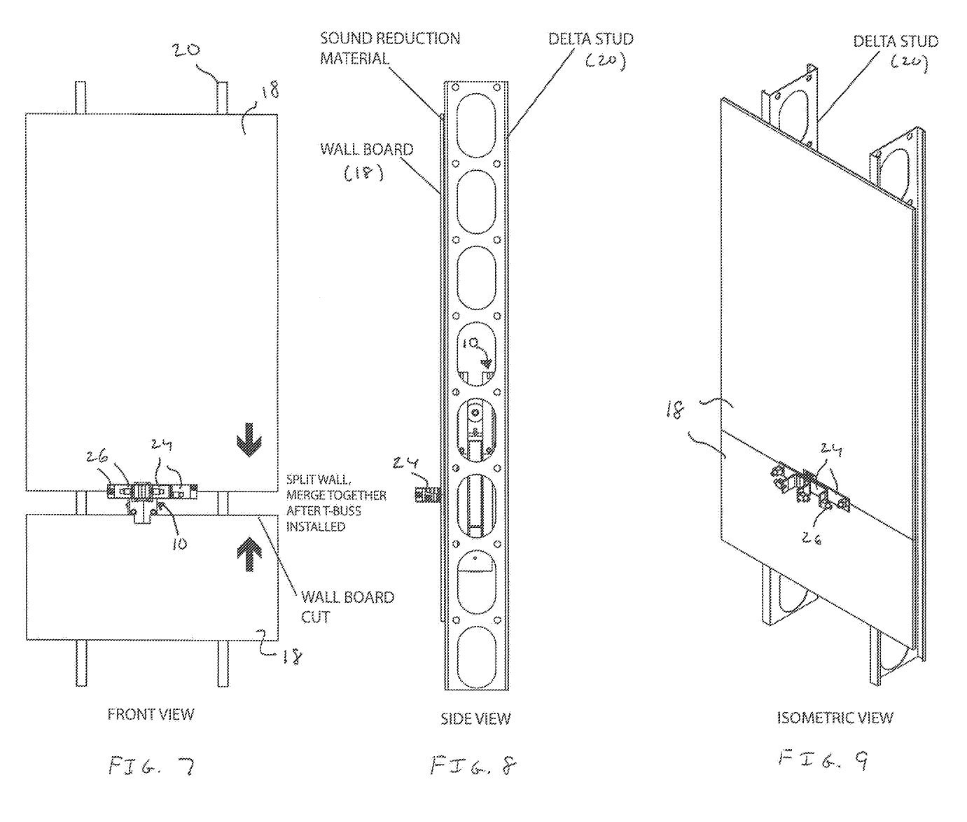

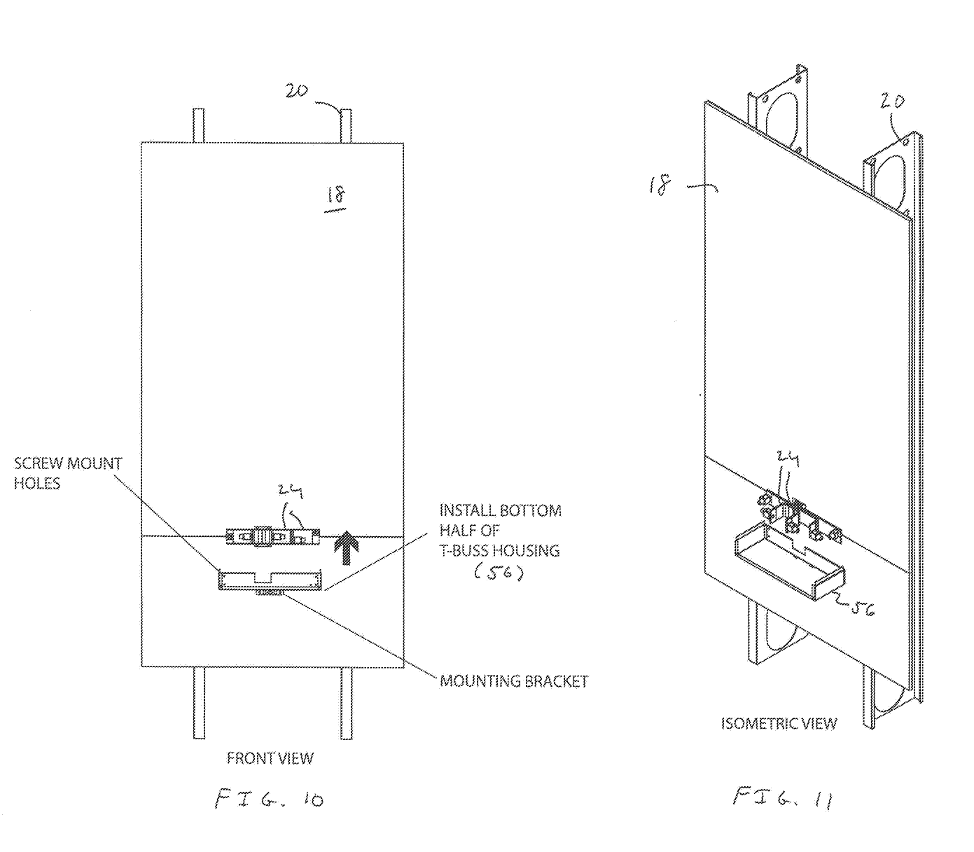

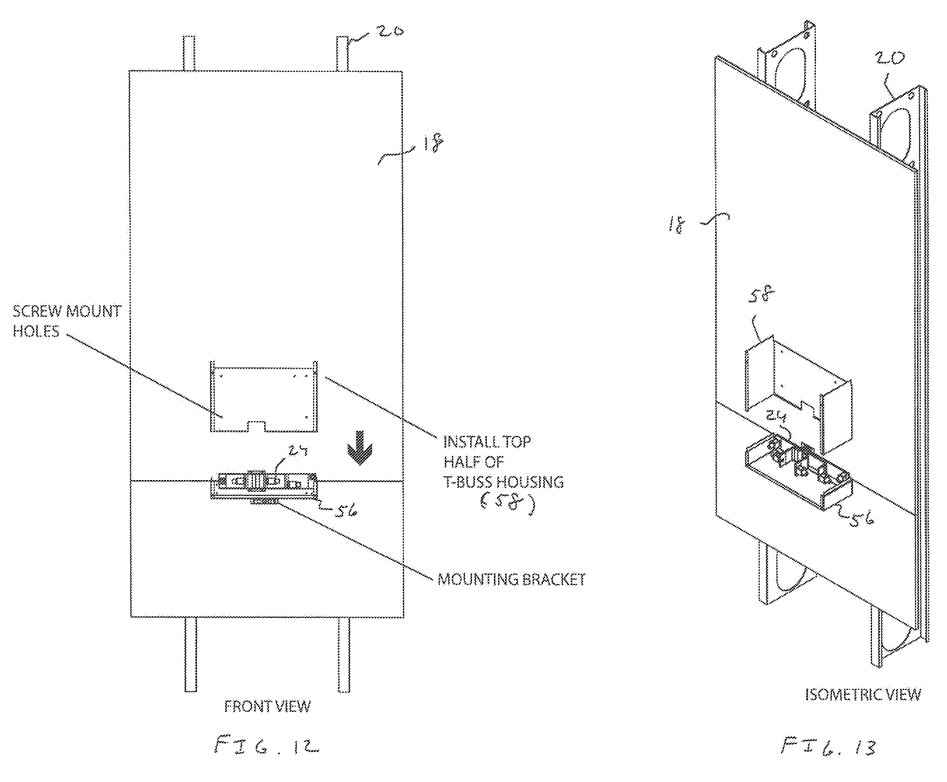

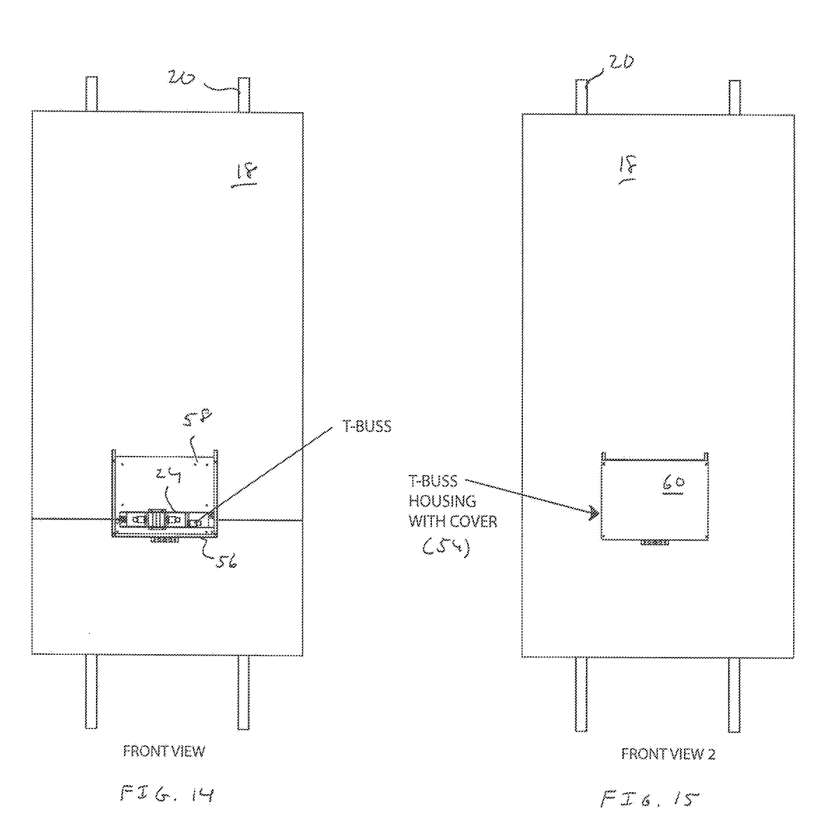

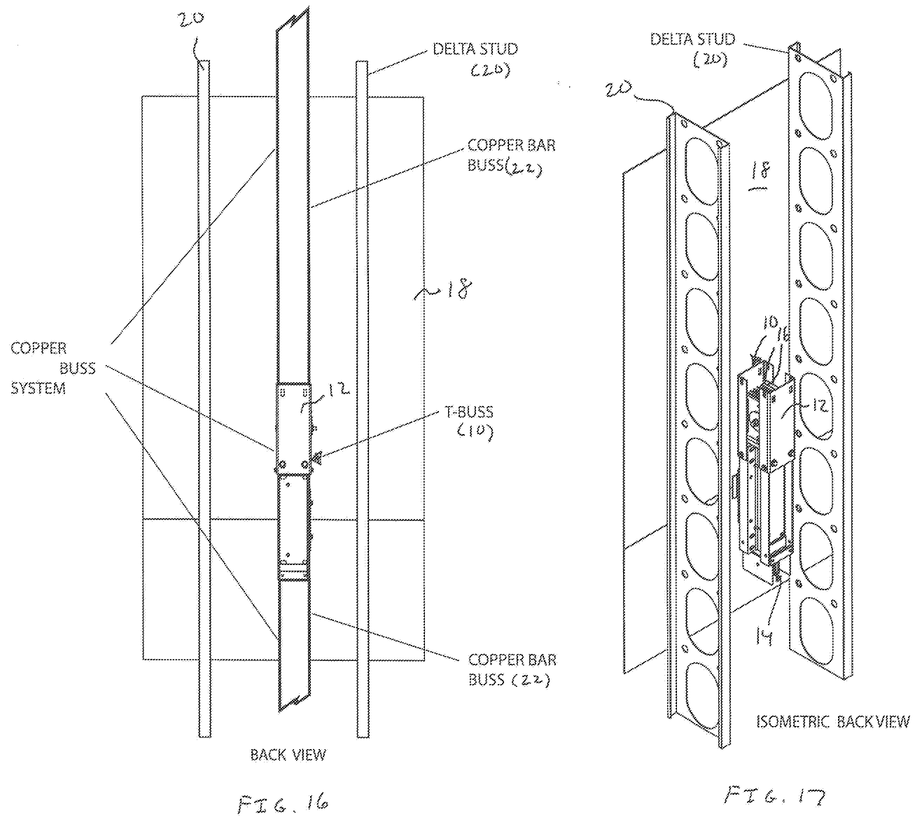

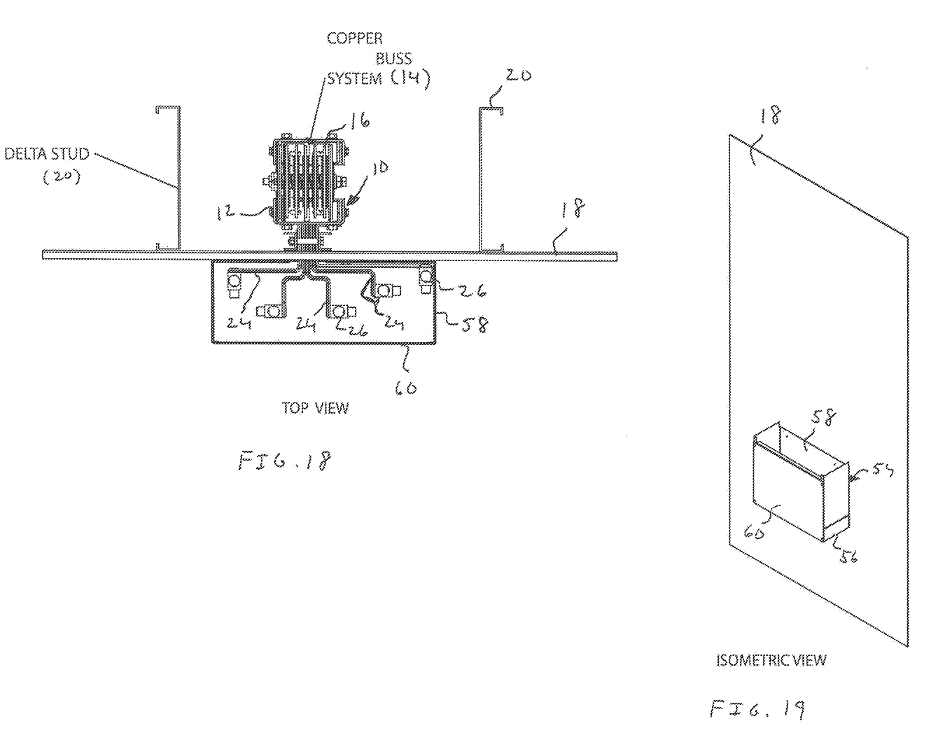

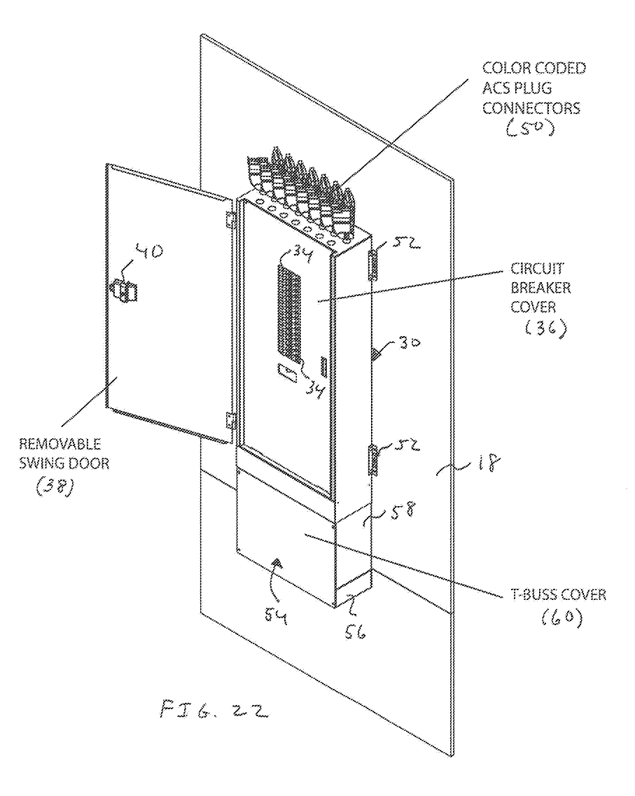

Referring now to FIGS. 1-2 and 7-23, the installation and interconnection of the busway 10 with the load center 30 will now be discussed. The busway 10 may be installed at a suitable location on one side of the wall 18, which may preferably be a fire-rated wall, and the wall 18 may include multiple sections and/or and opening in order to accommodate the flat-bar conductors 24 of the busway 10. The flat-bar conductors 24 of the T-buss 17 extend through the wall 18, and are thereby positioned on an opposite side of the wall 18 than the busway 10. The busway 10 may be attached to the wall 18 itself, or to other structure members 20 of the building structure by a support structure (not shown). A T-buss housing, generally indicated by reference numeral 54 as shown in FIG. 28, may be installed over the flat-bar conductors 24 extending from the wall 18 in order to protect the flat-bar conductors 24 and guard against accidental contact with the flat-bar conductors 24. The T-buss housing 54 may include a bottom portion 56 that may be mounted to the wall 18 by one or more fasteners and/or one or more mounting brackets. The T-bus housing 54 may also include a top portion 58 that may be mounted to the wall 18 by one or more fasteners and/or one or more mounting brackets (not shown). The top portion 58 interconnects with the bottom portion 56 in order to provide an enclosure for the flat-bar conductors 24 of the busway 10. The T-bus housing 54 may also include a cover 60 that forms an enclosure with the top portion 58 and the bottom portion 56 to substantially surround the flat-bar conductors 24 on at least five sides. In this manner, once the T-buss housing 54 has been installed on the wall 18, the flat-bar conductors 24 are protected from mechanical damage and are also protected from accidental electrical contact once the flat-bar conductors 24 have been energized.

Referring now to FIGS. 20-23, the installation of the load center 30 and interconnection of the load center 30 with the busway 10 will now be discussed. The load center 30 may be mounted on the wall 18 by using the one or more mounting brackets 52 and suitable fasteners, such as screws, bolts, lag bolts or the like. The load center 30 is installed on the wall 18 so that the bottom surface of the load center 30 covers the top of the T-bus housing 54 so that the flat-bar conductors 24 positioned within the T-bus housing 54 are completely enclosed by the load center 30 and the T-bus housing 54. Once the load center 30 has been secured in the proper location relative to the T-bus housing 54 on the wall 18, one or more conductor cables and/or wires are connected between the appropriate electrical component portions, e.g. ground 42, neutral buses 44, of the load center and the corresponding lugs 26 of the appropriate flat-bar conductors 24. For example, the cable or wire connected to the ground 42 in the load center 30 is connected to the lug 26 of the flat-bar conductor 24 that is the ground (GND). Preferably, wires 51 that have already been connected to the appropriate electrical components of the load center 30, for example during factory manufacture of the load center 30, are used instead having the need to make new wire connections. In this manner, all that is required for electrical interconnection of the load center 30 and the busway 10 is electrical connection of the appropriate cable or wire 51 to the corresponding lugs 26 of the flat-bar conductors 24. The cables or wires 51 may be identified through indicia, such as numbers or letters, or by color-coding in order to facilitate electrical interconnection to the corresponding lugs 26. However, it is understood that the present invention is not limited to any particular electrical interconnection mechanisms and/or techniques between the load center 30 and the busway 10. Preferably, these would be the only electrical connections required to be made by a certified electrician in accordance with building code and/or ordinance in accordance with the various embodiments of the present invention.

It is therefore understood that the interconnection of the busway 10 and the load center 30 through the T-buss 17 permits rapid and efficient installation of electrical distribution systems in a building structure. For example, the busway 10 may be constructed rapidly using multiple connections in order to distribute electricity throughout the building structure without the need for multiple wire connections being made. For example, the main electrical line of the building structure may be electrically connected to a first set of electrical buss conductors 22, which are then electrically coupled to a first busway 10, which may be electrically coupled to one or more load centers 30 by one or more T-busses 17. In this manner, the amount of time required to make the electrical connections between the busways 10 located through the building structure is greatly reduced, because the need to run individual electrical cables between the main building electrical distribution center and each load center 30 in order to distribute electricity throughout the building is obviated.

It will thus be seen that the objects set forth above, among those made apparent from the preceding description, are efficiently attained and, since certain changes may be made in the above article without departing from the scope of this invention, it is intended that all matter contained in this disclosure or shown in the accompanying drawings, shall be interpreted, as illustrative and not in a limiting sense. It is to be understood that all of the present figures, and the accompanying narrative discussions of corresponding embodiments, do not purport to be completely rigorous treatments of the invention under consideration. It is to be understood that the above-described arrangements are only illustrative of the application of the principles of the present invention. Numerous modifications and alternative arrangements may be devised by those skilled in the art without departing from the scope of the present invention.

What is claimed is:

1. A busway, comprising:
a bus system having one or more bus conductors; and
a T-buss extending from the bus system and having one or more flat-bar conductors;
wherein each of the one or more bus conductors is electrically coupled to a corresponding one of the one or more flat-bar conductors;

2. The busway according to claim 1, wherein each of the one or more bus conductors are comprised of an electrically conductive flat-bar.

3. The busway according to claim 1, wherein each of the one or more bus conductors are comprised of an electrically conductive cable.

4. The busway according to claim 1, wherein the T-buss extends substantially perpendicular to the bus system.

5. The busway according to claim 1, wherein the bus system is configured for connection to another bus system of another busway through one or more electrical buss conductors.

6. The busway according to claim 1, wherein each of the one or more flat-bar conductors comprises a lug for electrical connection to an electrical wire.

7. The busway according to claim 1, wherein each of the one or more flat-bar conductors is configured for electrical connection to an electrical wire of a load center.

8. The busway according to claim 7, wherein the load center comprises an enclosure having one or more circuit breakers disposed therein and a skirt extending from the enclosure.

9. The busway according to claim 7, wherein the one or more flat-bar conductors are electrically coupled the corresponding electrical wire of a load center by a lug.

10. The busway according to claim 7, wherein electrical wire connections of the load center are made prior to electrically coupling the load center to the one or more flat-bar conductors.

11. The busway according to claim 1, wherein the one or more bus conductors are comprised of copper or aluminum.

12. The busway according to claim 1, wherein the one or more bus conductors and the one or more flat-bar conductors are constructed of a rigid conductive material.
